(19) United States
(12) Patent Application Publication
(10) Pub. No.: US 2019/0259037 A1
(43) Pub. Date: Aug. 22, 2019

(54) INFORMATION PROCESSING DEVICE, INFORMATION PROCESSING METHOD, PROGRAM, AND STORAGE MEDIUM

(71) Applicant: Rakuten, Inc., Tokyo (JP)

(72) Inventor: Satoshi KIMURA, Tokyo (JP)

(73) Assignee: Rakuten, Inc, Tokyo (JP)

(21) Appl. No.: 16/348,400

(22) PCT Filed: Nov. 9, 2016
(86) PCT No.: PCT/JP2016/083226

§ 371 Date: May 8, 2019

(51) Int. Cl. G06Q 30/00; G06Q 30/06

(52) U.S. Cl. CPC G06Q 30/016; G06Q 30/0631

(57) ABSTRACT

An information processing device calculates, for each operation of a user, a fraud determination score based on a determination item according to an operation type, determines, in response to an operation of a user, a level of fraud of the operation based on a log of the fraud determination score of an operation type identical to an operation type of the operation, execute, on a user who has executed an operation determined as having a high possibility of fraud regarding the level of fraud, an identity confirmation process at a time of the operation, and executes a payment method change process on a user determined as having a high possibility of fraud at a time of product purchase.

### TECHNICAL FIELD

The present invention relates to an information processing device, an information processing method, a program, and a storage medium and specifically relates to a technique to detect a fraud operation of a user.

### CITATION LIST

### Patent Literatures

Patent Literature 1: JP H11-259571 A

### BACKGROUND ART

A spread of the Internet allows users to execute various actions without directly going to shops.

The user can, for example, purchase a product, apply for an insurance, and open a bank account using an Electronic Commerce (EC) website by using an information processing device (for example, a Personal Computer (PC)) at home.

However, since the user can, for example, purchase the product without meeting an employee of the shop, a fraud such as an impersonation of another person to purchases the product has been easily committed.

To prevent damage due to the fraud operation, determination whether the operation of the user is executed by a person himself/herself or not is important. However, execution of this operation by manpower is inefficient and becomes difficult as a volume of trade increases.

In view of such circumstances, Patent Literature 1 describes a configuration to automatically determine whether an operation of a user commits a fraud or not.

### SUMMARY OF INVENTION

### Technical Problem

Although the configuration described in Patent Literature 1 can determine whether the target operation itself is a fraud or not, the configuration cannot comprehensively determine that the operation is the fraud or not including various operations of the user until then.

Taking such situation into consideration, an object of the present invention is to execute a comprehensive fraud detection including operations of a user until then.

### Solution to Problem

An information processing device according to the present invention includes a score calculation unit, a determination unit, an identity confirmation process unit, and a payment method change process unit. The score calculation unit calculates, for each operation of a user, a fraud determination score based on a determination item according to an operation type. The determination unit determines, in response to an operation of a user, a level of fraud of the operation based on a log of the fraud determination score of an operation type identical to a type of the operation. The identity confirmation process unit executes, on a user who has executed an operation determined as having a high possibility of fraud regarding the level of fraud, an identity confirmation process at a time of the operation. The payment method change process unit executes a payment method change process on a user determined as having a high possibility of fraud at a time of product purchase.

That is, the level of fraud is determined for each operation of the user according to information at the time of the operation until then (such as input information and environment information), not only to the information on this operation (such as the input information and the environment information).

The following is preferable. The score calculation unit in the above-described information processing device executes a score re-calculation process of re-calculating the already calculated fraud determination score for a user who has executed an operation determined as having a low possibility of fraud as a result of the identity confirmation process.

This corrects the fraud determination score that has not been accurately calculated, thus calculating the accurate score.

The following is preferable. The score calculation unit in the above-described information processing device calculates the fraud determination score based on a normal status managed for each user based on latest user information. Initial registration information on the user is regarded as the normal status, and after a user information change operation that is estimated to be executed by a person himself/herself, registration information at a time of the user information change operation is regarded as the normal status.

Accordingly, the fraud determination score is calculated according to the latest registration information of the user (the attribute information and the environment information of the user).

The following is preferable. The score calculation unit in the above-described information processing device calculates the fraud determination score based on a weighting of each user set to each of the determination items.

This calculates the fraud determination score according to a situation of the user.

The following is preferable. The determination unit in the above-described information processing device executes the determination based on a determination threshold for each user. The determination threshold is changed according to a number of calculations of the fraud determination score.

This calculates the fraud determination score according to an operation frequency of the user.

The above-described information processing device is preferably configured as follows. The level of fraud has at least three levels of a high fraud determination, a medium fraud determination, and a low fraud determination. The information processing device further includes a notification unit that notifies an administrator of identification information of a user to whom the medium fraud determination has been given.

Thus, the administrator is notified of the information of a selected subset of users, for example, when the administrator manually confirms the information on the operation of the user in the case where the determination whether the operation is the fraud operation or not is difficult.

The following is preferable. The notification unit in the above-described information processing device notifies a process result of each of the determination items together with identification information of the user.

Thus, for example, the administrator is notified of an influence of the determination item given to the calculation of the fraud determination score when, for example, the administrator manually confirms the information on the operation of the user in the case where the determination whether the operation is the fraud operation or not is difficult.

The following is preferable. The score calculation unit in the above-described information processing device calculates the fraud determination score based on related fraud determination score.

This calculates the fraud determination score according to the fraud determination score of another operation type. For example, when the user information change operation is executed immediately after a login operation, the login operation immediately before the user information change operation is determined as the related operation, and the fraud determination score for the user information change operation immediately after the login operation is calculated based on the fraud determination score for this login operation.

The following is preferable. The determination unit in the above-described information processing device changes a determination threshold such that the level of fraud is likely to be determined higher than usual in a predetermined period after a user information change operation and executes the determination.

Accordingly, for example, after an operation of changing an address of a destination, a level-of-fraud determination process stricter than usual (that is, the fraud determination is likely to be high) is executed.

An information processing method according to the present invention is an information processing method performed by an information processing device. The method includes: a score calculation step of calculating, for each operation of a user, a fraud determination score based on a determination item according to an operation type; a determination step of determining, in response to an operation of a user, a level of fraud of the operation based on a log of the fraud determination score of an operation type identical to a type of the operation; an identity confirmation process step of executing, on a user who has executed an operation determined as having a high possibility of fraud regarding the level of fraud, an identity confirmation process at a time of the operation; and a payment method change process step of executing a payment method change process on a user determined as having a high possibility of fraud at a time of product purchase.

This information processing method provides an environment that executes a comprehensive fraud detection including the operations of the user until then.

A program according to the present invention is a program that causes a processing unit to execute a process executed as the information processing method.

A storage medium according to the present invention is a storage medium that stores the above program.

### Advantageous Effects of Invention

The present invention allows executing the comprehensive fraud detection including the operations of the user until then.

### BRIEF DESCRIPTION OF DRAWINGS

FIG. 1 is a drawing illustrating an overall configuration according to an embodiment of the present invention.

FIG. 2 is a block diagram of a fraud monitor device according to the embodiment.

FIG. 3 is a block diagram of a computer according to the embodiment.

FIG. 4 is a drawing illustrating an example of information stored in a score DB.

FIG. 5 is a flowchart describing an entire flow.

FIG. 6 is a flowchart describing an entire flow.

FIG. 7 is a flowchart describing a flow of processes by the fraud monitor device.

FIG. 8 is a flowchart describing another example of the entire flow.

FIG. 9 is a flowchart for a marked-user notification process.

FIG. 10 is a flowchart for another example of a score calculation process.

FIG. 11 is a flowchart for yet another example of the score calculation process.

FIG. 12 is a flowchart for another example of a level-of-fraud determination process.

### DESCRIPTION OF EMBODIMENTS

The embodiments describe a fraud monitor device 1 as an information processing device executing a fraud detection as an example.

The following describes the embodiments in the order listed below.

### <1. Overall Configuration>

### <2. Hardware Configuration>

<3. DB s>

### [3-1. User DB]

### [3-2. Shop DB]

### [3-3. Log DB]

### [3-4. Product DB]

### [3-5. Web Page DB]

### [3-6. Score DB]

### [3-7. Card DB]

### [3-8. Card Usage Log DB]

### <4. Flow of Processes>

### [4-1. Entire Flow]

### [4-2. Flow of Processes by Fraud Monitor Device]

### [4-3. Another Example of Entire Flow]

### [4-4. Marked-User Notification Process]

### [4-5. Another Example of Score Calculation Process]

### [4-6. Yet Another Example of Score Calculation Process]

### [4-7. Another Example of Level-of-Fraud Determination Process]

### <5. Modifications>

### <6. Summary>

### <7. Program>

### 1. OVERALL CONFIGURATION

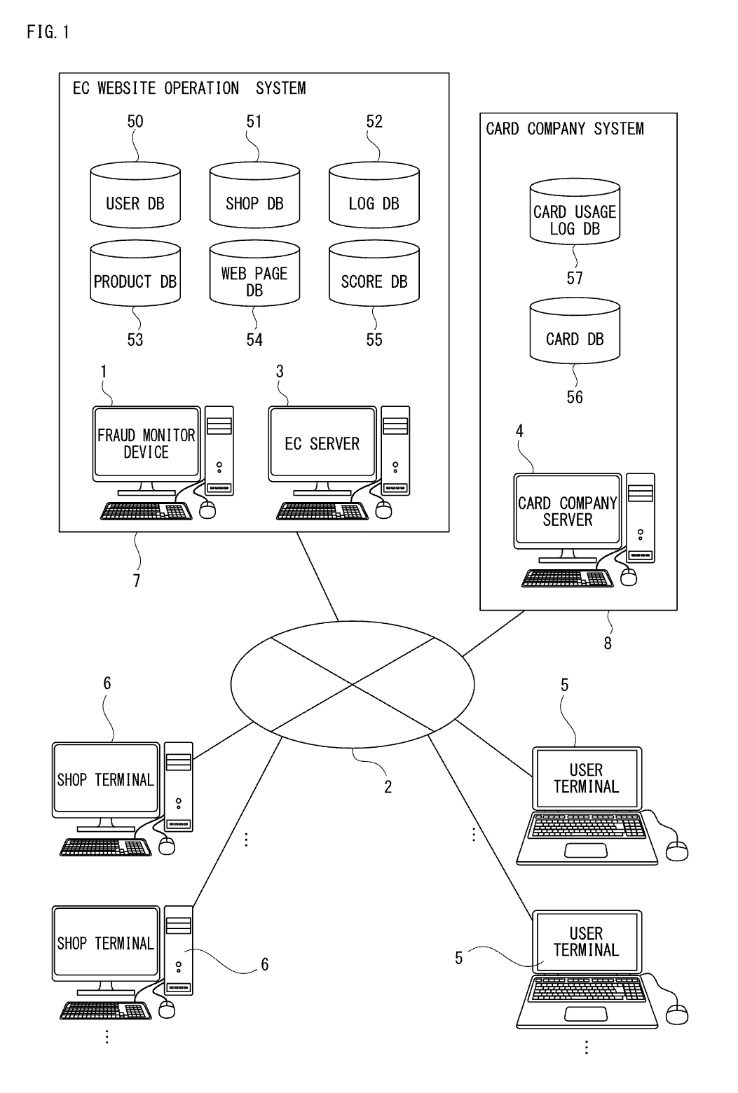

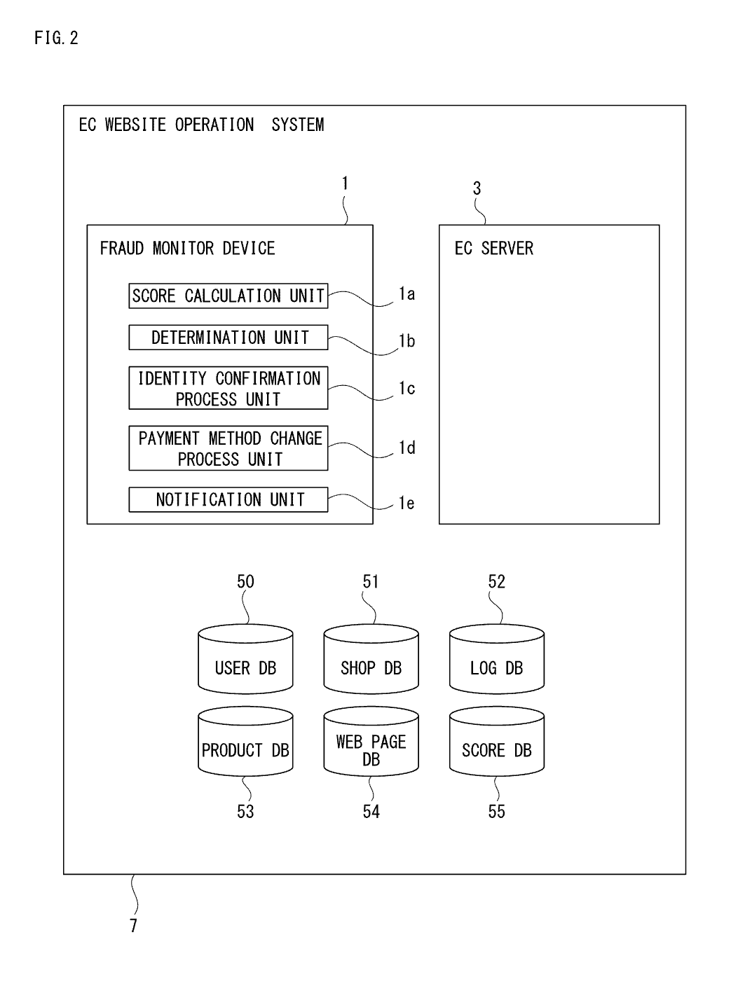

The following describes a configuration of an entire network system including the fraud monitor device 1 as the embodiment with reference to FIG. 1 and FIG. 2.

As illustrated in FIG. 1, the fraud monitor device 1 of the embodiment is coupled to an EC server 3, a card company server 4, and user terminals 5, 5, 5 . . . in a mutually communicative state. The EC server 3, for example, sells products through an electronic commerce using a communication network 2. The card company server 4 executes various processes regarding credit cards used to purchase the products. The user terminals 5, 5, 5 . . . are used by users using the electronic commerce.

The fraud monitor device 1 is an information processing device that executes various processes (the details will be described later) to determine whether various operations executed in the use of the electronic commerce by the users are frauds or not.

A configuration of the communication network 2 is not especially limited. For example, the Internet, an intranet, an extranet, a Local Area Network (LAN), a Community Antenna TeleVision (CATV) communications network, a Virtual Private Network, a telephone network, a mobile communications network, a satellite communications network, or a similar network is assumed.

Various examples are also assumed as transmission medium configuring all or a part of the communication network 2. The transmission medium, for example, can be a wire such as an Institute of Electrical and Electronics Engineers (IEEE) 1394, a Universal Serial Bus (USB), a power-line carrier, and a telephone line; and also a wireless such as infrared light like Infrared Data Association (IrDA), Bluetooth (registered trademark), 802.11 wireless, a mobile telephone network, a satellite channel, and a digital terrestrial broadcasting network.

The EC server 3, for example, provides a virtual mall (hereinafter referred to as “shopping website”) including a plurality of web pages as the electronic commerce using the communication network 2 to provide various functions related to browsing and purchase of the products sold there.

Specifically, the EC server 3 has a function to register information on the products (product information) sold by people in charge of EC (hereinafter referred to as vendors) of a plurality of shops joining the virtual mall, which is run using the EC server 3, and a function to change the registered product information. Therefore, the EC server 3 has a function to manage member shop information and the product information.

The EC server 3 also has functions such as a function that searches a product desired by the user among a product group dealt in the shopping website and presents the product, a function that orders a product to the vendor when the user executes a purchase operation of the product, a payment process function that mediates an exchange of a charge when the purchase and sale of the product are established, a function that delivers the product to each user, a notification function to the user when the purchase of the product is settled, and a function that notifies the vendor of user information who has purchased the product.

For the user to purchase the product, addressee (address) information of the product, a credit card number, and information on a contact address (such as a telephone number and an e-mail address) are required. To eliminate a labor to input these pieces of information each time that the user purchases the product, the EC server 3 has a function to manage the user information.

The EC server 3 executes a creation process and a transmission process of web page data to display web pages as user interfaces achieving the above-described various functions on the other information processing devices (the user terminals 5 and shop terminals 6).

The web page data is a structured document file such as Hyper Text Markup Language (HTML) and Extensible HyperText Markup Language (XHTML). The structured document file describes text data such as a description of the product, image data such as a product image, and arrangements and display formats (such as a character color, a font, a size, and a decoration) of the data.

The web page includes, for example, a login page that causes the user and a person who has requested a distribution to input login information and a web page to input advertising content.

The EC server 3 has functions such as an authentication function of the user and the vendor, a registration function of the information with various databases, and a function of obtaining the information from the various databases.

To achieve the above-described various functions, the EC server 3 manages a user DB 50, a shop DB 51, a log DB 52, a product DB 53, and a web page DB 54. The user DB 50 stores the user information. The shop DB 51 stores the information on the shop selling the product. The log DB 52 stores operation logs of the user. The product DB 53 stores information on the products dealt in the shopping website. The web page DB 54 stores the web page data of the various web pages.

The fraud monitor device 1, which monitors the fraud by users using the shopping website, obtains the information stored in the user DB 50 and the log DB 52 for use of various processes such as a fraud detection described later. The fraud monitor device 1 stores scores (values determining a level of fraud, described later) for each operation of the users, determination results given to the users, and the like in a score DB 55.

The card company server 4 executes processes regarding the credit cards. Specifically, the card company server 4 manages the information on the credit card, executes a credit reference by designating the number of the credit card, a process regarding a claim for sales, and a similar process.

For these processes, the card company server 4 manages a card DB 56 storing the information on the credit card and a card usage log DB 57 storing usage logs of the credit card.

The user terminal 5 is a terminal used by the user who uses the shopping website.

The shop terminal 6 is a terminal used by the vendor.

The user terminal 5 and the shop terminal 6 execute various transmission/reception processes, display processes, and similar processes as necessary. The user terminal 5 and the shop terminal 6 are, for example, a Personal Computer (PC) having a communication function, a feature phone and a Personal Digital Assistant (PDA), or a smart device such as a smart phone and a tablet terminal or the like.

Although not illustrated, terminals of member shops of a credit card brand cooperating with a card company running the card company server 4 are also coupled to the communication network 2 in a communicative state with the above-described respective information processing devices.

As illustrated in FIG. 1, the fraud monitor device 1, the EC server 3, the user DB 50, the shop DB 51, the log DB 52, the product DB 53, the web page DB 54, and the score DB 55 constitute an EC website operation system 7.

The card company server 4, the card DB 56, and the card usage log DB 57 constitute a card company system 8.

The fraud monitor device 1 needs not to be included in the EC website operation system 7 but may be independent.

The following describes the respective units provided with the fraud monitor device 1 with reference to FIG. 2.

The fraud monitor device 1 includes a score calculation unit 1a, a determination unit 1b, an identity confirmation process unit 1c, a payment method change process unit 1d, and a notification unit 1e.

The score calculation unit 1a executes a score calculation process of calculating a fraud determination score according to a determination item for each operation of the user. The determination item is set to each type of the operation (hereinafter described as “operation type”). The operation type is, for example, a “login operation,” a “user information change operation,” and a “purchase operation.”

The following describes an example of the determination items set to each operation type. The determination items for the “purchase operation” are, for example, the following items.

(K1) Is the IP address (Internet Protocol Address) normal?

(K2) Is the address not changed in the most recent predetermined period?

(K3) Is the purchase volume proper?

(K4) Is the product category to which the purchase product belongs appropriate?

(K5) Is the credit card information not changed in the most recent predetermined period?

(K6) Is the web browser (software installed on the user terminal 5 for display of the web page on the user terminal 5) not changed?

(K7) Is the language set to the web browser (hereinafter referred to as “web browser language”) not changed?

(K8) Is the operation aspect proper?

The following describes specific determinations based on the determination items as examples.

For example, in the determination item (K1), a user who connects to the EC server 3 with an IP address that has been used until now is determined as a low level of fraud.

On the other hand, the user who connects to the EC server 3 with an IP address that has never been used until now is determined as a slightly high level of fraud. Especially, a user connecting to the EC server 3 from a country different from a residence of this user is determined as a high level of fraud.

In the determination item (K4), a user who attempts to purchase a product belonging to a product category from which a product has been purchased until now is determined as the low level of fraud.

On the other hand, a user who attempts to purchase a product belonging to a product category from which the product has not been purchased until now is determined as the slightly high level of fraud. Especially, a user who has purchased exclusively products for men until now attempts to purchase a product for women is determined as an extremely high level of fraud.

That is, the product category in the embodiment includes not only the product category into which the respective products are categorized in the shopping website but also includes a concept by which the products can be grouped like “for men” and “for women.”

The fraud determination score is a numerical expression of high and low of a suspicion of fraud calculated based on the above-described determination items for each operation of the user. For example, a high fraud determination score is given to an operation having a high possibility of fraud, and a low fraud determination score is given to an operation having a low possibility of fraud. As one example, the fraud determination score is defined as a value from 0 to 100. As the possibility of fraud of the operation becomes high, the given value becomes high.

The fraud determination score (0 to 100) is an addition of points of the respective determination items. The maximum point is set to each determination item (for example, 12.5 points per item in the case of eight items), and the addition of the score for each determination item calculated for the respective eight items (hereinafter referred to as “score by item”) is defined as the fraud determination score.

The maximum values of the scores by item (for example, 12.5 points described above) may be a uniform value among all determination items or may be set by weighting among the determination items. For example, a high value may be defined as the maximum value of the score by item to the determination item regarded as important. Specifically, 20 points may be defined as the full marks of the respective (K2) and (K7), 10 points may be defined as the full marks of the other respective six items, and thus the total 100 points may be defined as the full marks.

The weighting among the determination items may be changed depending on the user. Specifically, it is considered that the weighting on (K1) is reduced to the user who frequently changes the IP address and the weighting on (K1) is increased to the user using the identical IP address every time.

To calculate the fraud determination score according to the determination item, a criterion status is required. For example, to determine whether or not the IP address is normal (K1) for determination whether the purchase operation executed by the user is the fraud operation or not, the IP address serving as the criterion (namely, a comparison target) is required. The status serving as the criterion differs depending on each user and is stored in the user DB 50.

Hereinafter, this status serving as the criterion is referred to as “normal status.”

Regarding the normal status, initial registration information when user registration is executed is registered as the “normal status” first. The initial registration information is not always limited to the information input by the user (for example, an address, an age, and a hobby). Terminal information and web browser information (for example, a type of the software), the IP address and an input state (including a character input speed, a usage state of a keyboard, and a usage state of a computer mouse), and the like used at the user registration are regarded as the initial registration information.

The score by item may be calculated based on another score by item. For example, in the case of (K1) and (K2) related to one another, the score by item for (K2) may be varied according to the score by item for (K1). That is, the score by item for (K2) with (K1) of zero points and the score by item for (K2) with (K1) of 10 points may be different values.

The fraud determination score may also be calculated based on another fraud determination score. For example, when the purchase operation is executed immediately after the user information change operation, it is estimated that both operations are related to one another, and therefore the fraud determination score of the purchase operation may be calculated based on the fraud determination score of the user information change operation.

The score calculation unit 1a executes a score re-calculation process of re-calculating the fraud determination score (and the score by item) calculated once. Timing for the score re-calculation process is, for example, when the normal status is changed.

Specifically, in the case where a user who uses an IP address from which the user connects from “Tokyo” is distinguishable until then uses an IP address from which the user connects from “Osaka” is distinguishable, the score by item for (K1), which is related to this operation, is calculated high. However, as soon as an identity confirmation process described later confirms that the connection from “Osaka” is executed by the person himself/herself, the score re-calculation process is executed, and the score by item for (K1), which has been calculated high, is re-calculated and is set low.

Then, the IP address of Osaka is added to the normal status of the target user in addition to the IP address of Tokyo. That is, as long as the IP address corresponds to any of the registered IP addresses, the score by item for (K1) is calculated low. Obviously, in the case where the IP address of Tokyo is not used due to a circumstance such as a move, the IP address of Tokyo is preferably deleted from the normal status. For this operation, for example, the fraud monitor device 1 may be configured to delete the IP address unused for a predetermined period.

Note that the determination items for the “login operation” and the “user information change operation” are, for example, (K1), (K6), (K7), and (K8) described above.

In the case where the score by item for the “user information change operation” is calculated, the score may be calculated low when the change is the appropriate change. Specifically, for example, when the operation of changing the information on the credit card is the change corresponding to an expiration of the card, this user information change operation has a high possibility of the appropriate operation.

The determination unit 1b executes a process to determine the level of fraud of the operation of the user according to the calculated fraud determination score (level-of-fraud determination process). The following gives examples of a first level-of-fraud determination process and a second level-of-fraud determination process as the level-of-fraud determination process.

The following example describes an example of providing three levels as the levels of fraud (“white determination” as the low level of fraud, “black determination” as the high level of fraud, and “gray determination” intermediate between the white determination and the black determination).

The first level-of-fraud determination process executes the determination considering only the fraud determination score given to one operation target for the determination (hereinafter referred to as “target operation”).

The second level-of-fraud determination process executes the determination considering logs of the fraud determination score given to an operation type identical to the target operation in addition to the fraud determination score for the target operation.

For example, the first level-of-fraud determination process determines the level of fraud using a first determination threshold. The first determination threshold includes a set of two numerals, for example, includes a threshold for distinction between the “white determination” and the “gray determination,” “30 points,” and a threshold for distinction between the “gray determination” and the “black determination,” “60 points.”

Specifically, 0 to 29 points are determined as the “white determination,” 30 to 59 points as the “gray determination,” and 60 to 100 points as the “black determination.”

Therefore, in the first level-of-fraud determination process, the fraud determination score given to the operation as the determination target of “20 points” is determined as the “white determination,” “50 points” is determined as the “gray determination,” and “90 points” is determined as the “black determination.”

The determination result in the first level-of-fraud determination process is referred to as a first determination result.

The second level-of-fraud determination process determines the level of fraud using a second determination threshold. The second determination threshold includes a set of two numerals as well, for example, includes a threshold for distinction between the “white determination” and the “gray determination,” “150 points,” and a threshold for distinction between the “gray determination” and the “black determination,” “300 points.”

For example, according to an “accumulated fraud determination score” found by adding the fraud determination scores of 10 pieces of the most recent “login operation,” whether the level of fraud corresponds to any of the “white determination,” the “gray determination,” and the “black determination” is determined.

At this time, the accumulated fraud determination score of 0 to 149 points is determined as the “white determination,” 150 to 299 points as the “gray determination,” and 300 to 1000 points as the “black determination.”

The determination result in the second level-of-fraud determination process is referred to as a second determination result.

In the exemplifications described in the above-described examples, setting the second determination threshold (for example, “150 points”) to be a value smaller than 10 times (to calculate the accumulated fraud determination score with 10 pieces of the most recent fraud determination scores) the first determination threshold (for example, “30 points”) causes a possibility that the “gray determination” and the “black determination” are given in the second level-of-fraud determination process even when the first level-of-fraud determination process keeps giving the “white determination.” Thus, not only the determination of the level of fraud for each operation, but also the comprehensive determination of the level of fraud is possible.

The first determination threshold and the second determination threshold may be fixed values or may be changed depending on the user.

For example, it is considered that the determination thresholds are changed depending on each user according to the number of calculations of the fraud determination score. Specifically, reliability of the fraud determination scores is different between a user A with the number of calculations of the fraud determination score of three times and the respective scores of “zero points,” “five points,” and “five points,” and a user B with the number of calculations of the fraud determination score of 100 times and all scores falling within “zero points” to “five points.” That is, it is considered that a possibility of the next fraud determination score of the user B becoming “10 points” is smaller than that of the user A based on the logs until now.

Therefore, it is considered that the determination threshold of the user B set to be smaller than (that is, stricter than) that of the user A is appropriate.

The accumulated fraud determination score may be simply the addition of 10 pieces of the most recent fraud determination scores or may be an addition found by weighting the values as the most recent ones.

Further, the first determination threshold and the second determination threshold may be changed depending on the timing.

For example, regarding the “purchase operation” of the product in a predetermined period (for example, three days) after the “user information change operation” that changes a delivery destination of the product is executed, the determination threshold may set to be strict (namely, low).

The identity confirmation process unit 1c executes the identity confirmation process of confirming whether the operation is executed by the user himself/herself or not on the user who has executed this operation having the high level of fraud.

For example, the identity confirmation process is executed on the user to whom the “black determination” has been given in the first and the second level-of-fraud determination processes.

The identity confirmation process targets for all user operations as the targets for the level-of-fraud determination process. That is, when the “black determination” is given to the “login operation,” the identity confirmation process is executed on this “login operation.” When the “black determination” is given to the “purchase operation,” the identity confirmation process is executed on this “purchase operation.”

For example, the following is possible as a method for the identity confirmation. A question whose answer is possibly known only to the user himself/herself is presented, and the confirmation is executed from the result of the answer.

It is also considered that a message or similar data is transmitted to another terminal (for example, a mobile phone) or the like estimated as being used by the user himself/herself, and the identity confirmation is executed from the response.

The payment method change process unit 1d executes a process of changing a payment method to the user who has executed the operation determined as the high level of fraud (for example, the user to whom the “black determination” has been given).

The payment method change is a process of, for example, blocking the use of the credit card and allows only transfer by cash as a method for payment of a charge in the purchase of the product.

While the execution timing of the payment method change process is timing at which the “purchase operation” is executed, the operation type generating an opportunity for the determination of the execution of the payment method change process needs not to be the “purchase operation.”

That is, according to the “user information change operation” becoming the “black determination,” the payment method change process may be executed at the subsequent “purchase operation.”

The notification unit 1e executes a marked-user notification process of notifying an administrator (a person executing the fraud detection) of the user with the level of fraud of the “gray determination.” The notification timing may be any timing, for example, may be immediately after that the “gray determination” is given or may be periodically, for example, once a day.

At the marked-user notification process, the notification unit 1e notifies the fraud determination score and the score by item for each determination item used for the determination result together with the determination result of the “gray determination.”

### 2. HARDWARE CONFIGURATION

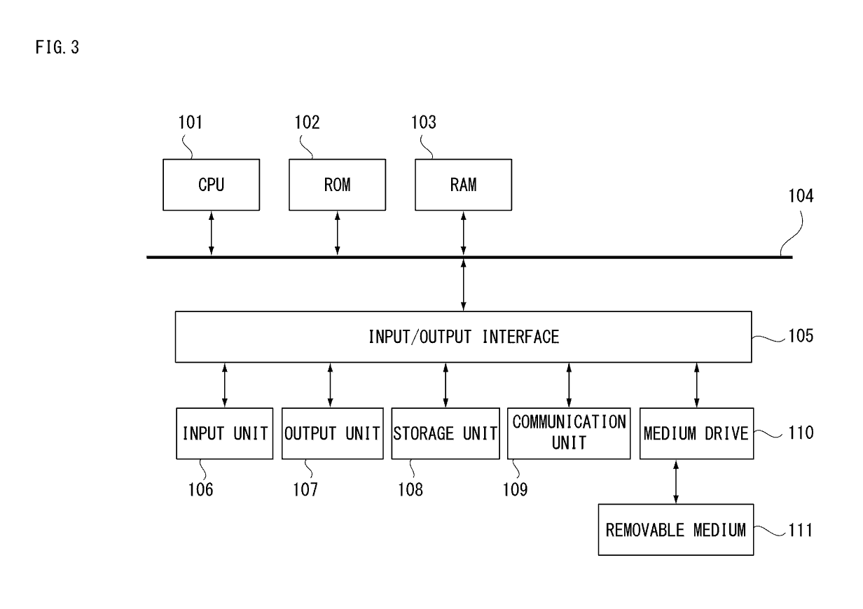

FIG. 3 is a drawing illustrating examples of hardware of the fraud monitor device 1, the EC server 3, the card company server 4, the user terminals 5, and the shop terminals 6 illustrated in FIG. 1, and the user DB 50, the shop DB 51, the log DB 52, the product DB 53, the web page DB 54, the score DB 55, the card DB 56, and the card usage log DB 57. A Central Processing Unit (CPU) 101 of a computer device in each server and terminal executes various processes in accordance with a program stored in a Read Only Memory (ROM) 102 or a program loaded from a storage unit 108 to a Random Access Memory (RAM) 103. The RAM 103 also appropriately stores data required for the CPU 101 to execute various processes or similar data.

The CPU 101, the ROM 102, and the RAM 103 are mutually coupled via a bus 104. To this bus 104, an input/output interface 105 is also coupled.

To the input/output interface 105, an input unit 106 that includes, for example, a keyboard, a computer mouse, a touchscreen, and a similar component; an output unit 107 that includes, for example, a display such as a Liquid Crystal Display (LCD), a Cathode Ray Tube (CRT), an organic Electroluminescence (EL) panel, and a speaker; the storage unit 108 that includes, for example, a Hard Disk Drive (HDD), a flash memory device, and a similar component; and a communication unit 109 executing a communication process and communications between devices via the communication network 2 are coupled.

Additionally, to the input/output interface 105, a medium drive 110 is coupled as necessary and a removable medium 111, such as a magnetic disk, an optical disk, a magneto-optical disk, or a semiconductor memory is appropriately mounted to write and read information to/from the removable medium 111.

Such computer device uploads and downloads data and the program through communications by the communication unit 109. Such computer device also can exchange the data and the program via the removable medium 111.

When the CPU 101 executes process operations based on various programs, information processing and communications described later are executed in each of the fraud monitor device 1, the EC server 3, the card company server 4, the user terminals 5, the shop terminals 6, and the user DB 50, the shop DB 51, the log DB 52, the product DB 53, the web page DB 54, the score DB 55, the card DB 56, and the card usage log DB 57.

Respective information processing devices that constitute the fraud monitor device 1, the EC server 3, the card company server 4, the user terminals 5, the shop terminals 6, and the user DB 50, the shop DB 51, the log DB 52, the product DB 53, the web page DB 54, the score DB 53, the card DB 56, and the card usage log DB 57 are not limited to be configured of a computer device as in FIG. 3 alone, and may be configured such that a plurality of computer devices are systemized. The plurality of computer devices may be systemized by the LAN and the like, or may be remotely disposed in a communicative state by a Virtual Private Network (VPN) or the like using the Internet or the like.

### 3. DBS

The following describes the various DBs managed by the EC server 3 and the card company server 4.

### [3-1. User DB]

The user DB 50 stores the information on the user who uses the shopping website provided by the EC server 3. For example, personal information such as a login password, a name, an age, a sex, an address, an e-mail address, a yearly income, and a hobby are associated with one user Identification (ID) and stored.

The user DB 50 stores the information as the above-described “normal status.”

For example, information on the product category that the user is interested in is stored. For example, the product category may be a comparatively large category such as “outdoor goods” and “sport goods,” may be further narrowed down, for example, “sports shoes manufactured by X company” and “jogging shoes,” or may be a keyword such as “made in Italy.”

Additionally, information on the operation state of the user is stored. As the operation state, for example, whether the user uses any of the “computer mouse” and the “keyboard” as operating means to switch a search field provided on the web page is stored.

Besides, a habit at the input or the like may be stored. For example, an input speed of characters, an input method (for example, kana input or a Roman character input) in the use of a language having a plurality of character input methods, and whether a suggested word is used may be stored.

Further, as long as an environment where the computer mouse trajectory is obtainable, a habit of the computer mouse trajectory may be stored.

### [3-2. Shop DB]

The shop DB 51 stores information on the shop and the vendor. For example, the shop DB 51 stores information such as a login password, a shop name, an address, a telephone number, an e-mail address, Uniform Resource Locator (URL) information on a shop page, sales product information (for example, a product ID and a product page URL), and shop logo information associated with one shop ID.

The product page URL is a URL given to each product page. When the product is identical but the vendors are different, different product page URLs are given.

The information on shop logo may be image data itself, may be link information (URL information) of the stored image data, or the like.

### [3-3. Log DB]

The log DB 52 stores various logs regarding the operations of the user.

Specifically, the log DB 52 stores information such as a log ID, an operation type, an operation target (for example, a target product ID for the “purchase operation” and an item name of a target for change for the “user information change operation”), date and time of the operation, and an operation result (login availability for the “login operation,” availability of the change for the “user information change operation,” and information indicative of whether the purchase has been executed or canceled for the “purchase operation.”

### [3-4. Product DB]

The product DB 53 stores information on the respective products that can be purchased and sold via the shopping website. For example, the product DB 53 stores information such as a product category, a product image, manufacturer (maker) information, model number information given by a manufacturer, a date when the sales starts, information on a provider of the dealt product, and inventory information associated with a product ID with which the product is uniquely identifiable.

The information on product image may be image data itself or may be link information (such as URL information) of the stored image data.

The product DB 52 may store information such as a place of production and specifications of the product (a color, a size, and performance information) in addition to the above-described information.

### [3-5. Web Page DB]

The web page DB 54 stores data of the various web pages provided to the users and the vendors from the EC server 3. Specifically, the web page DB 54 stores web page data such as a login page, a search page, a search result page, a product page, and various management pages.

The URL information of the web page and arrangement information of an object (such as an image, a text, and a banner) arranged on each web page are stored as the web page data. The arrangement information is information describing an arrangement state (such as a position, a size, and a color) of each object on the web page.

The information stored in the web page DB 54 may be stored as the structured document file such as HTML.

### [3-6. Score DB]

The score DB 55 stores the fraud determination score for each operation and the scores by item for each determination item.

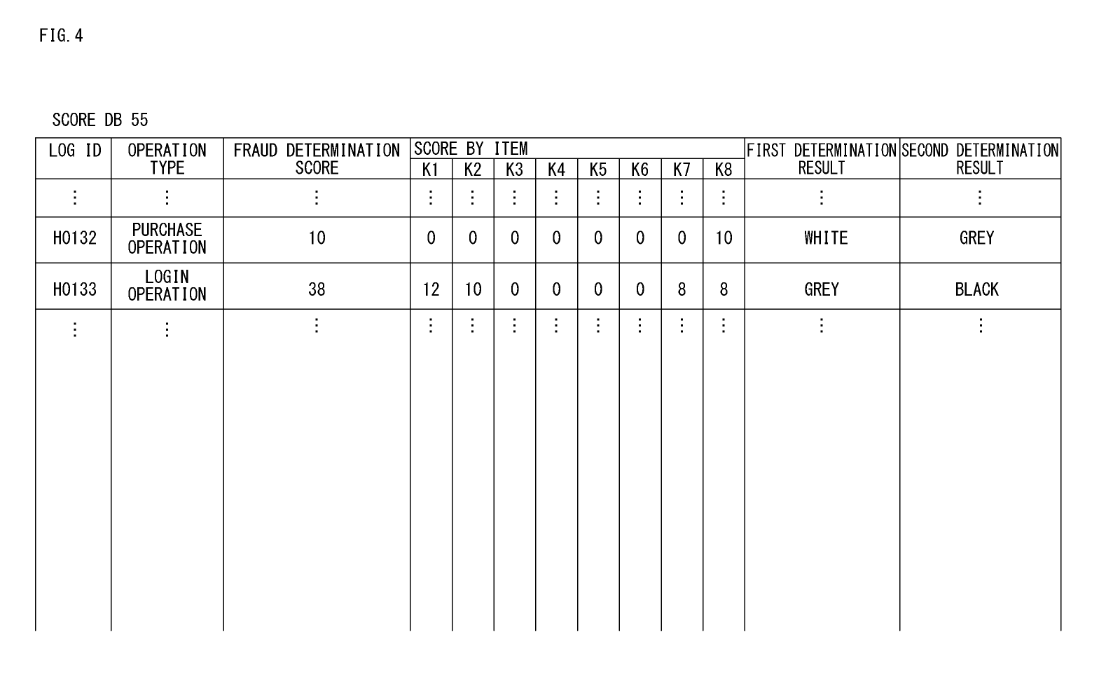

FIG. 4 illustrates a concrete example.

In the score DB 55 illustrated in FIG. 4, the “purchase operation” as the operation type, “10 points” as the fraud determination score, and the respective scores by item of (K1) to (K8) as the scores by item are associated with an operation log with the log ID of “H0132.”

Additionally, the “login operation” as the operation type, “38 points” as the fraud determination score, and the scores by item of (K1), (K6), (K7), and (K8) as the scores by item are associated with an operation log with the log ID of “H0133.”

The score DB 55 stores the first determination result and the second determination result of each operation.

Specifically, as illustrated in FIG. 4, the “white determination” as the first determination result and the “gray determination” as the second determination result are stored associated with the operation log with the log ID of “H0132.”

The “gray determination” as the first determination result and the “black determination” as the second determination result are stored associated with the operation log with the log ID of “H0133.”

The user ID is uniquely identifiable from the log ID. Therefore, the operation log of which user is identifiable based on the log ID.

Obviously, the user ID may be stored together with each log stored in the score DB.

### [3-7. Card DB]

The card DB 56 stores information such as a card number, a holder, a security code, a credit limit, a spending capacity, and expiration date of a credit card associated with the user ID managed by a card company.

The credit limit defines the spending limit of the card in each predetermined period such as one month, and the spending capacity is an amount of money found by subtracting the total sum of money used with the card in the predetermined period from this spending limit. The use of the card by the credit limit in the predetermined period sets the spending capacity 0 yen, thus disabling the use of the card any further in this predetermined period.

Here, for convenience of explanation, the information on the security code is assumed as being stored in the card DB 56. However, in the actual case, the information on the security code can be stored in storage means different from the card DB 56 for consideration of safety or a similar factor.

The user ID given to the user who uses the above-described EC website operation system 7 and the user ID given to the user who uses the card company system 8 described here may be different.

### [3-8. Card Usage Log DB]

The card usage log DB 57 stores usage log information such as a used amount of money, a date used, and a used shop associated with each card number of the credit card.

Each time the credit card is used, the card company server 4 newly associates the information such as the used amount of money, the date used, and the used shop with the card number of this credit card and stores the information in the card usage log DB 57.

### 4. FLOW OF PROCESSES

The following describes the flow of processes.

### [4-1. Entire Flow]

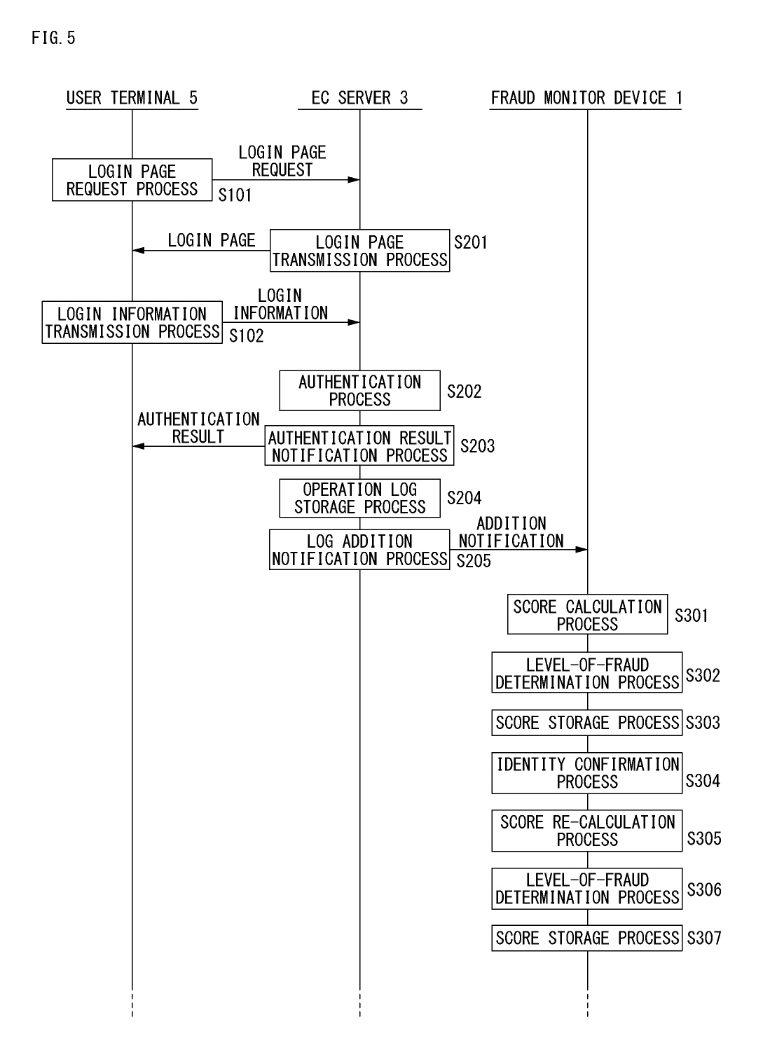

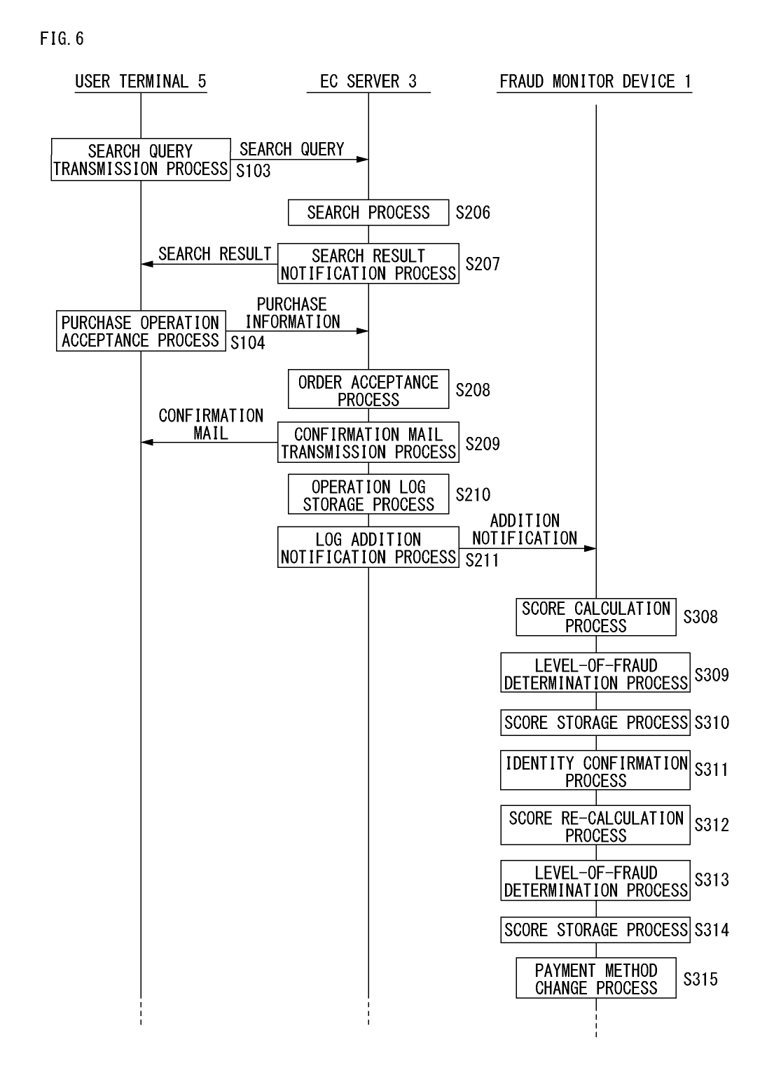

The following describes the entire flow with reference to FIG. 5 and FIG. 6 with an example of the execution of the login operation and the purchase operation by the user.

At Step S101, in response to an operation of displaying the login page by the user, the user terminal 5 executes a login page request process. When the user terminal 5 transmits a login page request to the EC server 3 by the login page request process, the EC server 3 executes a login page transmission process at Step S201.

Accordingly, for example, a web page according to login screen information (the web page data) to the shopping website received from the EC server 3 is displayed on the user terminal 5.

Next, at Step S102, the user terminal 5 executes a login information transmission process of transmitting the login information (the user ID and the login password) input by the user to the EC server 3. When the user terminal 5 transmits the login information to the EC server 3, the EC server 3 executes an authentication process at Step S202 and executes an authentication result notification process at the subsequent Step S203.

Specifically, the EC server 3 compares the user ID and the login password input on the user terminal 5 with the information stored in the user DB 50, determines the login availability of this user, and notifies the user terminal 5 of the authentication result. The EC server 3 may transmit web page data of a front page of the shopping website together with returning the authentication result to the user terminal 5. The user authentication is thus executed and the front page of the shopping website is displayed on the user terminal 5.

A sequence of the flows illustrated in FIG. 5 illustrates the case where it is determined that the login is allowed in the authentication process at Step S202. When it is determined that the login is not allowed at Step S202, the user terminal 5 re-executes the process of Step S102 and the EC server 3 executes the process of Step S202 according to this result.

Subsequently, at Step S204, the EC server 3 executes an operation log storage process of storing the logs of the operation (the login operation) of the user in the log DB 52. At the subsequent Step S205, the EC server 3 executes a log addition notification process of notifying the fraud monitor device 1 of the addition (the update) of the operation log in the log DB 52.

The fraud monitor device 1 that has received the addition notification executes a score calculation process at Step S301. In the score calculation process, the fraud monitor device 1 calculates the score by item for each determination item and the fraud determination score, which is the accumulation of the scores by item.

Subsequently, at Step S302, the fraud monitor device 1 executes a level-of-fraud determination process. Here, a first level-of-fraud determination process and a second level-of-fraud determination process are executed.

In the case where the logs of the fraud determination score given to the operation type identical to that of the target operation are absent, the second level-of-fraud determination process is not executed. That is, in the case where a log of another login operation is absent except for the current login operation, the second level-of-fraud determination process is not executed.

Next, at Step S303, the fraud monitor device 1 executes a process of storing the respective calculated scores and the like in the score DB 55.

In view of this, the score DB 55 illustrated in FIG. 4 newly stores the scores by item and the fraud determination score according to the log of the login operation (for example, the record with the log ID=H0133 in FIG. 4). Further, in this process, the determination result in the level-of-fraud determination process is stored in the score DB 55.

Subsequently, at Step S304, the fraud monitor device 1 executes an identity confirmation process. The identity confirmation process is unnecessary depending on the result of the level-of-fraud determination process at Step S302 in some cases, and the process of Step S304 is not executed in that case.

In the identity confirmation process, the fraud monitor device 1 executes a process of confirming whether the target operation (that is, the operation target for the score calculation at Step S301) is executed by the person himself/herself.

Next, at Step S305, the fraud monitor device 1 executes the score re-calculation process. This process is a process executed when the normal status is updated by the above-described identity confirmation process at Step S304 and is a process of re-calculating the highly calculated (that is, the high level of fraud) fraud determination score so as to be an appropriate value.

The fraud monitor device 1 re-executes the level-of-fraud determination process of Step S306 and a score storage process of Step S307.

These processes update the level of fraud as the determination result and updates the fraud determination score and the scores by item stored in the score DB 55.

Subsequently, the following describes processes by the respective information processing devices when the user using the user terminal 5 searches the product and purchases the product extracted as the search result with reference to FIG. 6.

First, at Step S103, the user terminal 5 executes a search query transmission process based on the search operation by the user. This process transmits a search query to the EC server 3.

At Step S206, the EC server 3 that has received the search query executes a search process. This process is a process of extracting the product according to the search query among the products stored in the product DB 53.

Subsequently, at Step S207, the EC server 3 executes a search result notification process. For example, in this process, the EC server 3 transmits search results with priority orders provided according to a user attribute or a similar factor to the user terminal 5.

The user terminal 5 that has received the search results presents the search results to the user. In response to the execution of the operation of selecting and purchasing the product from the search results by the user, the user terminal 5 executes a purchase operation acceptance process at Step S104.

In the purchase operation acceptance process, the user terminal 5 transmits a product ID and purchase conditions (such as a volume, a delivery destination, and a method of payment) of the product target for the purchase operation by the user as the purchase information together with the user ID of the user using the user terminal 5.

The EC server 3 that has received the purchase information executes an order acceptance process at Step S208.

In the order acceptance process, the EC server 3 executes a process of notifying the shop that puts up the product purchased by the user of the purchase information such as the product ID and the purchase volume of the purchased product and various processes such as a credit inquiry necessary to use the credit card.

These processes are executed collaborating with other information processing devices belonging to the EC website operation system 7 and the information processing devices belonging to the shop terminal 6 and the card company system 7.

Subsequently, the EC server 3 executes a confirmation mail transmission process at Step S209. In the confirmation mail transmission process, the EC server 3 transmits an e-mail as a confirmation of an acceptance of the order to the user terminal 5.

The terminal (for example, a mobile phone terminal) designated by the user using the user terminal 5 may be set as the transmission destination for the confirmation mail, not the user terminal 5.

At subsequent Step S210, the EC server 3 executes an operation log storage process.

In the operation log storage process, the EC server 3 stores the log based on the purchase operation executed by the user using the user terminal 5 in the log DB 52.

The EC server 3 executes a log addition notification process at Step S211.

In the log addition notification process, the EC server 3 notifies the fraud monitor device 1 of the addition (the update) of the operation log (here, the log of the purchase operation).

The fraud monitor device 1 that has received the addition notification executes the score calculation process, the level-of-fraud determination process, the score storage process, the identity confirmation process, the score re-calculation process, the level-of-fraud determination process, and the score storage process in this order at Step S308 to S314. These respective processes are similar to the above-described respective processes from Step S301 to S307; therefore, the following omits the details.

Subsequently, the fraud monitor device 1 executes a payment method change process at Step S315.

The payment method change process is a process of changing the payment method of the user who has executed the operation of high level of fraud.

The payment method change process is not executed on a user who has executed only the operation of low level of fraud.

The user who has executed the operation of high level of fraud is the user, for example, to whom the “black determination” has been given in the above-described level-of-fraud determination process at Step S313 where it is determined that the level of fraud of the previous purchase operation (Step S104) is high.

The payment method change process may be executed on the user who has executed the operation of high level of fraud until then, not only the previous purchase operation.

Besides, in the case where the operation to which the “black determination” has been given as the high level of fraud is included among the respective operations from the login operation for the previous purchase operation to this purchase operation, the payment method change process may be executed.

The fraud monitor device 1 that has executed the payment method change process may execute a process of notifying the user (namely, the user terminal 5) of the change in the payment method after the process of Step S315. To configure setting such that only the transfer by cash is allowed as the payment method, information on a payee and the like may be notified together.

The confirmation mail transmission process at Step S209 may be executed after the payment method change process of Step S315. That is, after fixing that which method is usable as the payment method (the method is transfer only or the credit card is usable), the confirmation mail may be transmitted to the user.

### [4-2. Flow of Processes by Fraud Monitor Device]

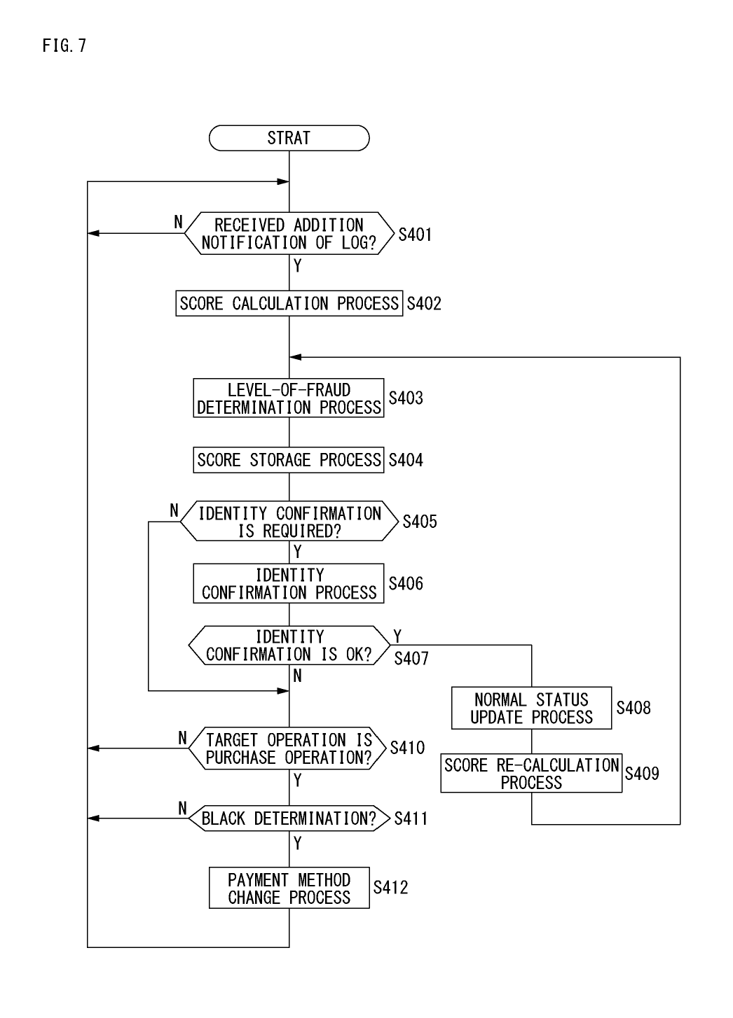

The following describes a process example executed by the fraud monitor device 1 to achieve the above-described flow of processes illustrated in FIG. 5 and FIG. 6 with reference to FIG. 7.

First, the fraud monitor device 1 executes a process of determining whether the addition notification of the log has been received or not at Step S401.

This process is a process of determining whether the addition notification notified from the EC server 3 has been received or not when the operation log according to the user operation is stored in the log DB 52. The addition notification is issued at the previous Step S205 of FIG. 5 and Step S211 of FIG. 6.

Subsequently, the fraud monitor device 1 executes the score calculation process at Step S402 (FIG. 7). At the score calculation process, the fraud monitor device 1 calculates the scores by item and the fraud determination score.

This process is a process of Step S301 in FIG. 5 and Step S308 in FIG. 6.

The fraud monitor device 1 executes the level-of-fraud determination process at Step S403 (FIG. 7). At the level-of-fraud determination process, the fraud monitor device 1 executes the first level-of-fraud determination process and the second level-of-fraud determination process.

This process is processes of Step S302 and Step S306 in FIG. 5 and Step S309 and Step S313 of FIG. 6.

Next, the fraud monitor device 1 executes the score storage process at Step S404 (FIG. 7). This process is a process of storing the various scores calculated in the score calculation process and the determination result in the level-of-fraud determination process in the score DB 55 and is processes of Steps S303 and S307 in FIG. 5 and Steps S310 and S314 in FIG. 6.

The execution from Steps S401 to S404 calculates the scores and determines the level of fraud in response to the reception of the notification process of the operation log, and the score DB 55 stores the results.

Subsequently, the fraud monitor device 1 executes a process of determining whether the identity confirmation process is required or not at Step S405 (FIG. 7).

In this process, for example, when the “black determination” has been given to the previous user operation, that is, the “black determination” has been given in the first level-of-fraud determination process, the identity confirmation process is determined to be required.

Except for this, in the case where the accumulation of the predetermined number of most recent fraud determination scores (the accumulated fraud determination score) among the user operations of the identical type (for example, the login operation) is determined as the “black determination,” that is, in the case where the “black determination” has been given in a second fraud determination level determination process, the identity confirmation process is required.

When it is determined that the execution of identity confirmation process is not required, the fraud monitor device 1 does not execute the processes of Steps S406 and S407 and transitions to a process of Step S410.

Meanwhile, when the execution of the identity confirmation process is determined to be required, the fraud monitor device 1 executes the identity confirmation process of Step S406.

As described in the description of the identity confirmation process unit 1c, in the identity confirmation process, the fraud monitor device 1 executes the identity confirmation by, for example, presenting the question whose answer is possibly known only to the person himself/herself. The process for the identity confirmation may be executed through the direct communications with the user terminal 5 or may be executed through communications via the EC server 3.

Subsequently, the result of the identity confirmation process is notified to the EC server 3.

The EC server 3 that has received the result of the identity confirmation process may execute measures against the fraud such as a restriction of the user operation after that in the shopping website.

The fraud monitor device 1 that has ended the identity confirmation process executes a process of determining whether the operation can be confirmed as the operation by the person himself/herself or not from the result of the identity confirmation process at the subsequent Step S407.

When the operation can be confirmed as the operation by the person himself/herself, that is, in the case of “OK” determination, the fraud monitor device 1 executes a normal status update process at Step S408.

This process is a process of updating the normal status according to information when the identity confirmation is successful by the identity confirmation process (for example, environment information such as the operation state of the user with the keyboard and the computer mouse, the IP address, and terminal information, and preference information such as category information of the browsed product). After that, the score calculation process is executed based on this updated normal status.

When the target operation is the “user information change operation,” in response to the successful confirmation that the user information change operation is executed by the person himself/herself, the normal status is updated to the changed user information. Accordingly, for example, even when the addressee address of the product is changed by a person other than himself/herself, the normal status is not updated unless the identity confirmation becomes successful. Thus, the fraud determination score calculated hereinafter becomes high and the level of fraud becomes a high value; therefore, the “black determination” is likely to be given in the level-of-fraud determination process.

After updating the normal status, the fraud monitor device 1 executes the score re-calculation process at Step S409.

This process is a process of updating the scores by item and the fraud determination score until now based on the updated normal status.

The fraud monitor device 1 that has updated the fraud determination score executes the processes of Steps S403 and S404.

Since the identity confirmation process has already been executed at a determination process of Step S405, the execution of the identity confirmation process is determined as unnecessary, and the process transitions to a process of Step S410.

At Step S410, the fraud monitor device 1 executes a process of determining whether an operation type of a target operation (in other words, the operation target for the addition notification at Step S205 in FIG. 5 and Step S211 in FIG. 6, the operation target for the calculation of the score by item) generating an opportunity to execute a sequence of the processes illustrated in FIG. 7 is the “purchase operation” or not.

When the target operation is not the “purchase operation,” the fraud monitor device 1 re-executes the process of Step S401.

Meanwhile, when the target operation is the “purchase operation,” the fraud monitor device 1 determines whether the determination result of this purchase operation (the first determination result or the second determination result) is the “black determination” or not at Step S411.

In the case of the “black determination,” the fraud monitor device 1 executes the payment method change process at Step S412. In the payment method change process, the fraud monitor device 1 changes the payment method (for example, a process of blocking the use of the credit card and switching the method to the transfer by cash) and notifies the user that the payment method has been changed.

After the execution of the process of Step S412, or when the target operation is determined as not the “purchase operation” at Step S410, or the target operation (the purchase operation) is determined as not the “black determination” at Step S411, the fraud monitor device 1 re-executes the process of Step S401.

That is, when the level-of-fraud determination process is executed on the “purchase operation” executed by the user, after the execution of the identity confirmation process, the score re-calculation process, or a similar process as necessary, whether this “purchase operation” is the “black determination” or not is confirmed, and the payment method is changed when the “purchase operation” is the “black determination.”

### [4-3. Another Example of Entire Flow]

Another example of the entire flow differs from the above-described example in a process after the authentication process.

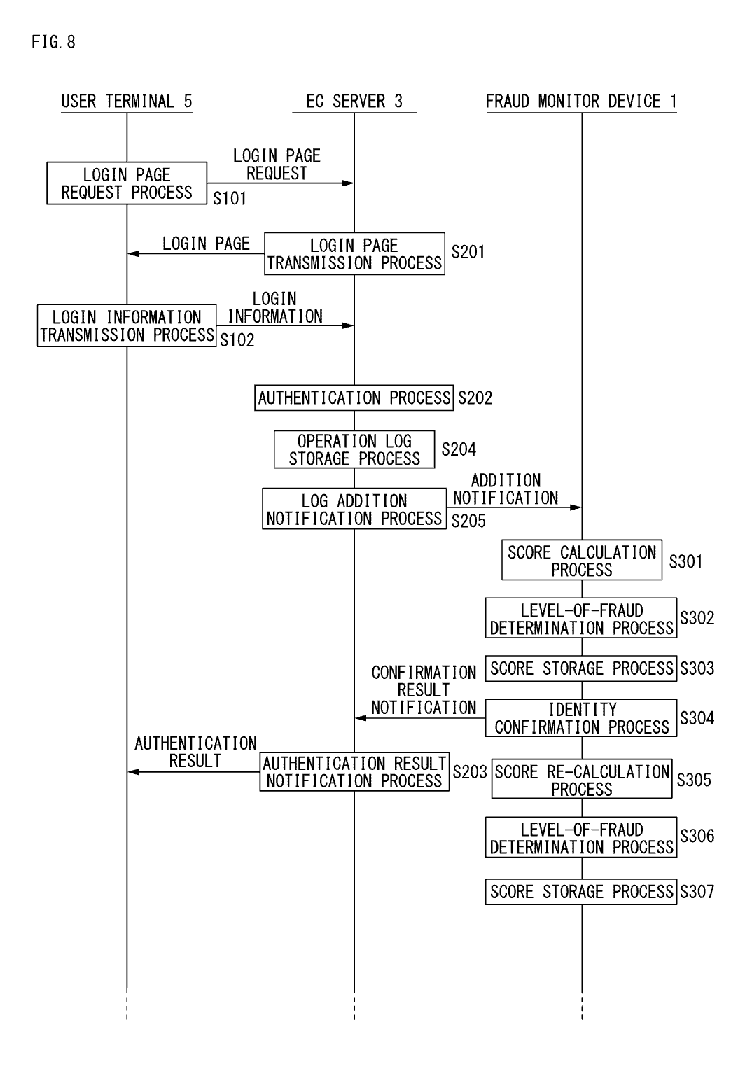

Specifically, the following describes the example with reference to FIG. 8.

The respective processes of Steps S101 and S102 executed by the user terminal 5 are similar to those of the above-described example. The respective processes of Steps S201 and S202 executed by the EC server 3 are also similar to those of the above-described example.

After execution of the authentication process of Step S202, the EC server 3 does not notify the authentication result immediately but executes the operation log storage process of Step S204 and subsequently executes the log addition notification process of Step S205.

Thus, before the user is notified of the authentication result, the fraud monitor device 1 is notified of the addition of the log. FIG. 8 illustrates a case where the authentication process (that is, a verification process of the user ID and the login password) of Step S202 has been normally authenticated.

The fraud monitor device 1 that has received the addition notification executes the respective processes from Step S301 to Step S304. Since these processes are similar to those of the above-described example, the following omits the detailed description.

In the identity confirmation process, the fraud monitor device 1 notifies the EC server 3 of the confirmation result.

The EC server 3 notified of the confirmation result executes the authentication result notification process at Step S203. This notifies the user of the authentication result.

When the confirmation result of the identity confirmation process is OK (that is, when it is confirmed that the operation is executed by the person himself/herself), the user terminal 5 is notified of the successful authentication in the authentication result notification process. When the identity confirmation process itself is unnecessary (for example, the fraud determination score is the “white determination”), the user terminal 5 is notified of the successful authentication.

Meanwhile, when the confirmation result of the identity confirmation process is NG, there are some possible examples.

For example, in the case where the identity confirmation fails even through the authentication process of Step S202 itself (that is, the verification process of the user ID and the login password itself) are successfully authenticated, although the login of the user is permitted, the subsequent user operation is possibly restricted.

Additionally, even when the authentication process is successfully authenticated, the login of the user itself is not permitted possibly. That is, until the identity confirmation becomes successful, the login is not permitted.

The fraud monitor device 1 that has executed the identity confirmation process executes the subsequent respective processes from Steps S305 to S307. Since these processes are similar to those of the above-described example, the following omits the detailed description.

### [4-4. Marked-User Notification Process]

The marked-user notification process is a process executed by the notification unit 1e in the fraud monitor device 1 and executed by a batch process or a similar process regularly, for example, once in 24 hours.

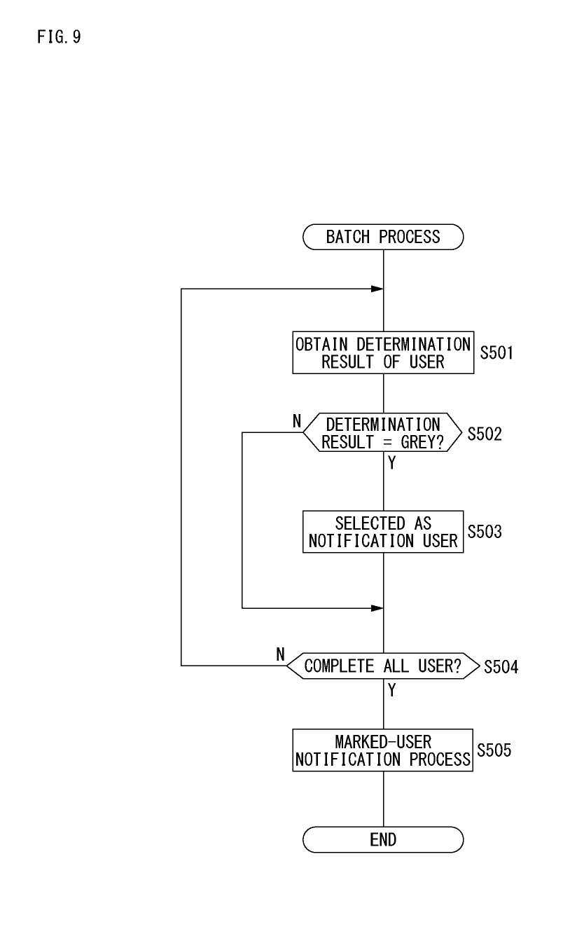

The following describes an example of the batch process with reference to FIG. 9.

First, at Step S501, the fraud monitor device 1 obtains a first determination result and a second determination result of certain one user (for example, a user A) from the score DB 55.

Here, the fraud monitor device 1 obtains only the added determination results further added after the determination results obtained by the previous batch process.

Subsequently, the fraud monitor device 1 executes a process of confirming whether the obtained first and second determination results are the “gray determination” or not at Step S502.

As the result of the confirmation, when the results are the “gray determination,” the fraud monitor device 1 executes a process of selecting this user as a notification user at Step S503.

Meanwhile, at Step S502, when the respective determination results are confirmed as not the “gray determination” or after the execution of Step S503, the fraud monitor device 1 determines whether the respective processes from Steps S501 to S503 have been executed on all users or not at Step S504.

When the process is not executed on all users, the fraud monitor device 1 re-executes the process of Step S501 to obtain a determination result of the next user (for example, a user B).

When the respective processes from Steps S501 to S503 have been executed on all users, the fraud monitor device 1 executes a process of notifying the administrator (the person executing the fraud detection) of the identification information (for example, the user IDs) of the respective users selected as the notification users at the subsequent Step S505.

At the notification process, the administrator may be notified of not only the identification information of the user but also the score by item for each determination item as the information as a source of the “gray determination.”

### [4-5. Another Example of Score Calculation Process]

The score calculation process of Step S402 and the score re-calculation process of Step S409 in FIG. 7 described above have described the examples where the fraud determination score (the score calculated corresponding to one user operation) is calculated based on only the determination items regarding the target operation.

Another example of the score calculation process describes an example of a calculation that also considers the related operation in addition to the target operation to calculate the fraud determination score corresponding to the target operation.

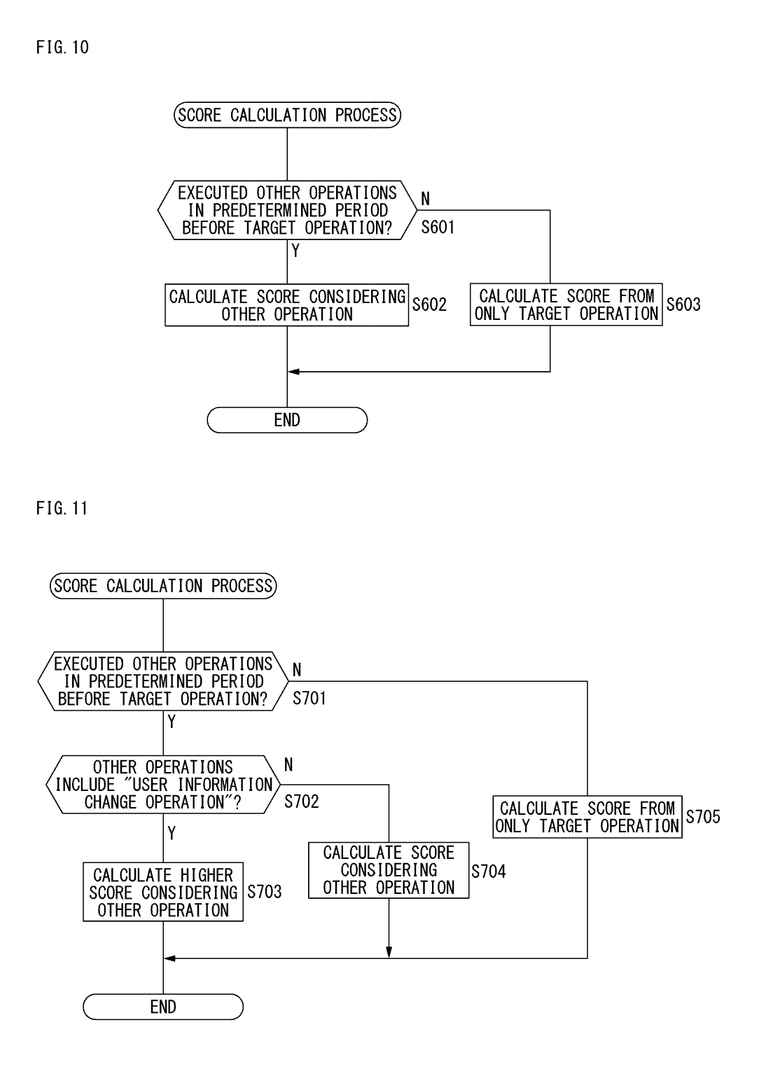

The following describes an example with reference to FIG. 10.

First, at Step S601, the fraud monitor device 1 executes a process of determining whether the identical user has executed other operations in a predetermined period before the target operation or not.

For example, with the “purchase operation” as the target operation and 10 minutes as the predetermined period, it is determined whether another operation (for example, the “login operation,” the “user information change operation,” and a “product browsing operation”) has been executed in 10 minutes before this purchase operation or not.

When it is determined that another operation has been executed in the predetermined period, the fraud monitor device 1 calculates the scores by item, the fraud determination scores, and the accumulated fraud determination score of the target operation considering this other operation at Step S602.

For example, it is assumed that the fraud determination score calculated from only the “purchase operation” as the target operation is low. However, in the case where the “user information change operation” with the high fraud determination score has been executed five minutes before the “purchase operation,” the fraud determination score for the “purchase operation” as the target operation is also calculated high considering the high fraud determination score for the “user information change operation” as the related operation.

To calculate high, a constant coefficient (for example, a value such as 1.2) may be multiplied to be calculated or a value according to the magnitude of the fraud determination score for the related operation may be multiplied as the coefficient to be calculated.

At Step S601, when it is determined that another operation is not executed in the predetermined period, the fraud monitor device 1 executes a process of calculating the scores by item, the fraud determination scores, and the accumulated fraud determination score for only the target operation at Step S603.

While the examples where the calculation methods (or the calculation formulae) of the respective scores are changed according to whether another operation has been executed in the predetermined period or not have been described, the methods may be changed according to whether a specific operation has been executed or not.

For example, with the “purchase operation” as the target operation, when the “user information change operation” that changes the delivery destination is executed in the predetermined period, the respective scores may be calculated high.

In the case where the “user information change operation” that changes the credit card information is executed in the predetermined period while the expiration date of the credit card is enough, the similar process may be executed.

### [4-6. Yet Another Example of Score Calculation Process]

The following describes yet another example of the score calculation process where whether the “user information change operation” is included in other operations executed in the predetermined period is considered with reference to FIG. 11.

First, at Step S701, the fraud monitor device 1 executes a process of determining whether the identical user has executed other operations in a predetermined period before the target operation or not. This process is similar to the process of Step S601 in FIG. 10.

When it is determined that the other operations have been executed in the predetermined period, the fraud monitor device 1 executes a process of determining whether these other operations include the “user information change operation” or not at Step S702.

When the other operations include the “user information change operation,” the fraud monitor device 1 calculates the respective scores so as to be values higher than those described above at Step S703.

Meanwhile, although the other operations have been executed, the “user information change operation” is not included in the operations, the fraud monitor device 1 calculates the respective scores so as to be high values (note that values lower than those of S703) at Step S704.

When it is determined that other operations have not been executed in the predetermined period at Step S701, the fraud monitor device 1 executes a process of calculating the respective scores from only the target operation at Step S705. This process is a process similar to Step S603 in FIG. 10.

### [4-7. Another Example of Level-of-Fraud Determination Process]

The yet another example of the score calculation process has described the example where the respective scores are calculated based on whether the other operations include the “user information change operation” or not.

However, thresholds (a first determination threshold and a second determination threshold) used for the level-of-fraud determination process may be changed without changing the respective calculated scores (namely, the values themselves).

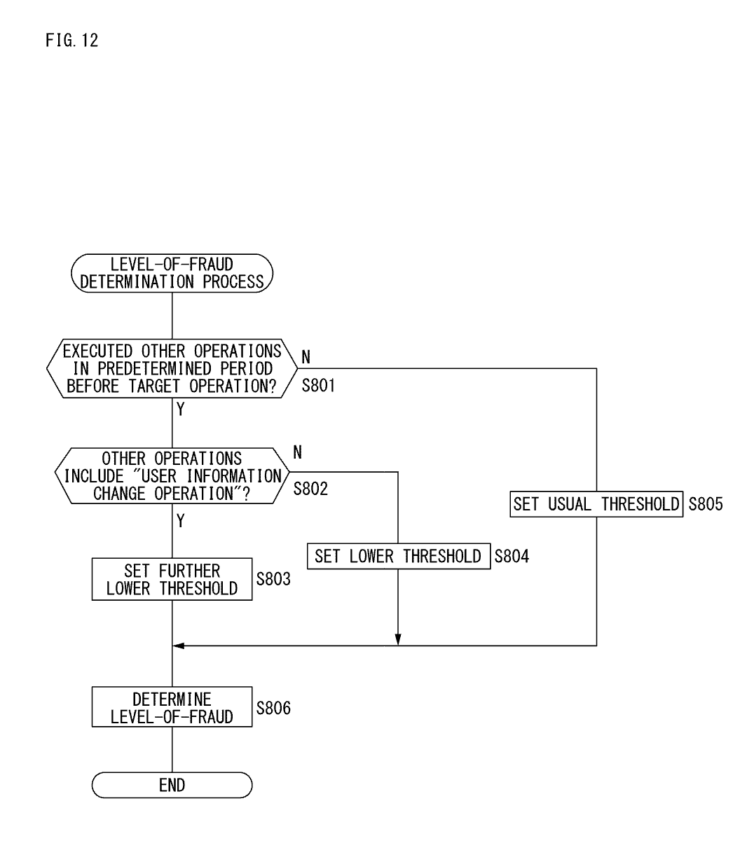

Here, the following describes an example where the level of fraud is determined based on whether the other operations include the “user information change operation” or not with reference to FIG. 12.

First, at Step S801, the fraud monitor device 1 executes a process of determining whether the identical user has executed other operations in a predetermined period before the target operation or not. This process is similar to the process of Step S601 in FIG. 10 and Step S701 in FIG. 11.

When it is determined that the other operations have been executed in the predetermined period, the fraud monitor device 1 executes a process of determining whether these other operations include the “user information change operation” or not at Step S802.

When the “user information change operation” is included in the other operations, the fraud monitor device 1 executes a process of setting a threshold low (set lower than that in Step S804 described later) at Step S803.

The threshold reset at this time may be any one of thresholds among two thresholds of the first determination thresholds and two thresholds of the second determination thresholds, four in total, may be the plurality of thresholds, or may be all thresholds.

Meanwhile, although the other operations have been executed, the “user information change operation” is not included in the operations, the fraud monitor device 1 executes a process of setting the low threshold (note that the threshold higher than that in Step S803 is set) at Step S804.

When it is determined that other operations have not been executed in the predetermined period at Step S801, the fraud monitor device 1 executes a process of setting a usual threshold at Step S805.

In the case where the usual threshold has been set from the beginning, Step S805 may be skipped.

Subsequently, the fraud monitor device 1 executes a process of determining the level of fraud based on the thresholds set based on the respective conditions at Step S806.

### 5. MODIFICATIONS

While the flowchart illustrated in FIG. 5 describes the example where the score calculation process, the storage process, and the identity confirmation process are not executed on the “search operation,” the “search operation” may be the target operation.

In such as case, for example, the score calculation and the determination process based on the determination items set to the “search operation” have been executed.

Besides, the “product browsing operation,” a “favorite registration operation” that registers the product with a favorite, or a similar operation may be the target operation.

### 6. SUMMARY

As described above, the fraud monitor device 1 includes the score calculation unit 1a, the determination unit 1b, the identity confirmation process unit 1c, and the payment method change process unit 1d. The score calculation unit 1a calculates, for each operation of the user, the fraud determination score based on the determination item (for example, K1 to K8) according to the operation type. The determination unit 1b determines, in response to an operation of the user, the level of fraud of the operation based on the log of the fraud determination score of the operation type identical to the type of the operation. The identity confirmation process unit 1c executes, on the user who has executed an operation determined as having the high possibility of fraud (that is, the “black determination” has been given) regarding the level of fraud, the identity confirmation process at the time of the operation. The payment method change process unit 1d executes the payment method change process on the user determined as having the high possibility of fraud at the time of product purchase (that is, at the “purchase operation”).

That is, the level of fraud is determined for each operation of the user according to the information at the time of the operation until then (such as the input information and the environment information), not only to the information on this operation (such as the input information and the environment information).

Therefore, the comprehensive fraud detection according to the operations of the user until then is executable.

Even when a different user has executed the identical operation, the logs of the fraud determination score for each operation of the user until then are different and the determination result of the level of fraud is different; therefore, the fraud detection appropriate for each user is executable.

Further, the execution of the payment method change process at the time of the product purchase allows preventing monetary damage.

The appropriate execution of the fraud detection allows reducing or cutting down a processing load on the information processing device when the fraud operation is accepted thereafter.

Additionally, the determination result is calculated for each operation type based on the accumulated fraud determination score that has been accumulated depending on each operation type (for example, the above-described “login operation,” “user information change operation,” and “purchase operation”). This allows the accurate determination of the level of fraud to the operation type. For example, when the operation type is not distinguished for the user whose fraud determination score for the “login operation” becomes likely to be high and thus the accumulated fraud determination score is calculated based on the most recent fraud determination score, the fraud determination score for the “login operation” increases the accumulated fraud determination score. Therefore, the level of frauds of other operation types (the “user information change operation” and the “purchase operation”) cannot be accurately grasped. Therefore, for example, in the case where the problematic operation type is identified according to a situation of the user and the measures against the fraud are taken, the measures against this user are not appropriately executed possibly. The above-described configuration allows the accurate determination of the level of fraud depending on each operation type; therefore, taking the appropriate measures against the fraud is possible.

As in the description of the score by item and the description of Step S409 in FIG. 7, the score calculation unit 1a executes the score re-calculation process of re-calculating the already calculated fraud determination score for the user who has executed the operation determined as having the low possibility of fraud as the result of the identity confirmation process.

This corrects the fraud determination score that has not been accurately calculated, thus calculating the accurate score.

Accordingly, the level of fraud of the user can be accurately determined.

For example, when an access is made from Osaka using a user ID of a user who accessed from Tokyo, the fraud determination score is calculated higher than the fraud determination score until then. However, at the point when the access from Osaka is confirmed as being executed by the person himself/herself, the already calculated fraud determination score is re-calculated; therefore, the fraud determination score is renewed to the value as usual and further the accumulated fraud determination score that has been accumulated also returns to normal.

Further, as in the description of the score by item, the score calculation unit 1a calculates the fraud determination score based on the normal status managed for each user based on the latest user information. At this time, the initial registration information on the user is regarded as the normal status is, and after the user information change operation that is estimated to be executed by the person himself/herself, the registration information at a time of the user information change operation is regarded as the normal status.

Accordingly, the fraud determination score is calculated according to the latest registration information of the user (the attribute information and the environment information of the user).

Therefore, the level of fraud can be appropriately determined.

Further, as in the description of the score by item, the score calculation unit 1a may calculate the fraud determination score based on the weighting of each user set to each of the determination items.

This calculates the fraud determination score according to the situation of the user.

Therefore, the level of fraud can be appropriately determined by reflecting the situation of the user.

In addition, the determination unit 1b executes the determination based on the determination threshold for each user. The determination threshold is changed according to the number of calculations of the fraud determination score.

This calculates the fraud determination score according to the operation frequency of the user.

Accordingly, the level of fraud appropriate for each user can be determined.

As in the description of the example of the batch process in FIG. 9, the level of fraud has at least the three levels of the high fraud determination (namely, the “black determination”), the medium fraud determination (namely, the “gray determination”), and the low fraud determination (namely, the “white determination”). The fraud monitor device 1 further includes the notification unit 1e that notifies the administrator of the identification information of the user to whom the medium fraud determination has been given.

Thus, the administrator is notified of the information of the selected subset of users, for example, when the administrator manually confirms the information on the operation of the user in the case where the determination whether the operation is the fraud operation or not is difficult.

This allows reducing the information volume notified to the administrator and also allows reducing a load on the administrator required for the confirmation work.

In other words, the user to whom the “black determination” has been given in the first level-of-fraud determination process and the second level-of-fraud determination process has the extremely high possibility of the level of fraud, and therefore the automatic handling by the fraud monitor device 1 is preferable from an aspect of a reduction in manpower cost.

Although the user to whom the “gray determination” has been given in the respective level-of-fraud determination processes is the user having the high possibility of the level of fraud, there is a possibility that the operation is executed by the original qualified user. Equally and automatically restricts the access of the user and restricts the operation of the user by the fraud monitor device 1 thus are not always appropriate.

Therefore, appropriately executing the determination of such user by the administrator who executes the measures against the fraud is considered to be preferable.

Meanwhile, the determination whether the fraud operation has been executed or not of all users including the users other than users to whom the “gray determination” has been given in eyes of the administrator increases the manpower cost and therefore is not preferable.

This configuration manually executes the fraud detection and the measures against the fraud by the administrator only on the users to whom the “gray determination” has been given. Accordingly, the appropriate fraud detection and measures against the fraud are executable while the increase in manpower cost is reduced.

Further, as described as in the example of the batch process in FIG. 9, the notification unit 1e notifies the process result of each of the determination items together with the identification information of the user.

Thus, for example, the administrator is notified of the influence of the determination item given to the calculation of the fraud determination score when, for example, the administrator manually confirms the information on the operation of the user in the case where the determination whether the operation is the fraud operation or not is difficult.

This allows further reducing the load on the administrator required for the confirmation work.

In other words, this configuration notifies the administrator of the score by item for each determination item together with the information identifying the user (for example, the user ID) to whom the “gray determination” has been given.

Thus, the influence of the determination item given to the calculation of the fraud determination score can be easily grasped, for example, when the administrator manually confirms the information on the user operation in the case where the determination whether the operation is the fraud operation or not is difficult.

This allows reducing the load on the administrator required for the works of the fraud detection and the measures against the fraud.

Further, as in the description of the score by item, the description of another example of the score calculation process, and the description of FIG. 10, the score calculation unit 1a calculates the fraud determination score based on the related fraud determination score.

This calculates the fraud determination score according to the fraud determination score of another operation type. For example, when the user information change operation is executed immediately after the login operation, the login operation immediately before the user information change operation is determined as the related operation, and the fraud determination score for the user information change operation immediately after the login operation is calculated based on the fraud determination score for this login operation.

Therefore, since the fraud determination scores for the respective operations are compositely calculated, the appropriate determination process of the level of fraud is executable.

In addition, as in the descriptions of another example of the level-of-fraud determination process and FIG. 12, the determination unit 1b changes the determination threshold such that the level of fraud is likely to be determined higher than the usual level of fraud in the predetermined period after the user information change operation and executes the determination.

Accordingly, for example, after the operation of changing the address of the destination, the level-of-fraud determination process stricter than usual (that is, the fraud determination is likely to be high) is executed.

Especially, in the purchase operation possibly causing monetary damage actually, setting the determination threshold high in the case where the purchase operation is executed in the predetermined period after the user information change operation allows increasing a possibility of avoiding the damage caused by the fraud operation.

### 7. PROGRAM

The programs in the respective embodiments are the programs executed by the processing unit (for example, the CPU) provided with the fraud monitor device 1.

This program causes the processing unit to execute a score calculation function that calculates, for each operation of the user, the fraud determination score based on the determination item according to the operation type.

Additionally, the program causes the processing unit to execute a determination function that determines, in response to an operation of a user, the level of fraud of the operation based on the log of the fraud determination score of the operation type identical to this operation.

Further, the program causes the processing unit to execute, on the user who has executed the operation determined as having the high possibility of fraud regarding the level of fraud, an identity confirmation process function that executes the identity confirmation process at a time of the operation.

The program causes the processing unit to execute a payment method change process function that executes the payment method change process on the user determined as having the high possibility of fraud at a time of product purchase.

That is, this program is a program that causes the processing unit to execute the respective processes of Steps S301 to S307 of FIG. 5, the respective processes of Steps S308 to S315 of FIG. 6, the respective processes of FIG. 7, the respective processes of Steps S301 to S307 of FIG. 8, and the respective processes of FIG. 9 to FIG. 12.

Such programs allow achieving the above-described fraud monitor device 1.

Then, such program can be preliminarily stored in an HDD as a storage medium incorporated in equipment such as a computer device, a ROM in a microcomputer including a CPU, and the like. Alternatively, such program can be temporarily or permanently saved (stored) in a removable storage medium such as a semiconductor memory, a memory card, an optical disk, a magneto-optical disk, and a magnetic disk. Such removable storage medium can be provided as what is called package software.

Such program can be installed into a personal computer and the like from the removable storage medium, and can be downloaded from a download website via a network such as a LAN and the Internet.

### REFERENCE SIGNS LIST

1 fraud monitor device, 1a score calculation unit, 1b determination unit, 1c identity confirmation process unit, 1d payment method change process unit, 1e notification unit, 2 communication network, 3 EC server, 4 card company server, 5 user terminal, 6 shop terminal, 7 EC website running system, 8 card company system, 50 user DB, 51 shop DB, 52 log DB, 53 product DB, 54 web page DB, 55 score DB, 56 card DB, 57 card usage log DB

1-12. (canceled)

13. An information processing device comprising:
at least one memory configured to store computer program code;
at least one processor configured to access said computer program code and operate as instructed by said computer program code, said computer program code including:
score calculation code configured to cause at least one of said at least one processor to calculate, for each operation of a user, a fraud determination score based on a determination item according to an operation type;
determination code configured to cause at least one of said at least one processor to determine, in response to an operation of a user, a level of fraud of the operation based on a log of the fraud determination score of an operation type identical to an operation type of the operation;
identity confirmation process code configured to cause at least one of said at least one processor to execute, on a user who has executed an operation determined as having a high possibility of fraud regarding the level of fraud, an identity confirmation process at a time of the operation; and
payment method change process code configured to cause at least one of said at least one processor to execute a payment method change process on a user determined as having a high possibility of fraud at a time of product purchase.

14. The information processing device according to claim 13, wherein
the score calculation code is configured to cause at least one of said at least one processor to execute a score re-calculation process of re-calculating the already calculated fraud determination score for a user who has executed an operation determined as having a low possibility of fraud as a result of the identity confirmation process.

15. The information processing device according to claim 13, wherein
the score calculation code is configured to cause at least one of said at least one processor to calculate the fraud determination score based on a normal status managed for each user based on latest user information, and
initial registration information on the user is regarded as the normal status, and after an user information change operation that is estimated to be executed by the user himself/herself, registration information at a time of the user information change operation is regarded as the normal status.

16. The information processing device according to claim 13, wherein
the score calculation code is configured to cause at least one of said at least one processor to calculate the fraud determination score based on a weighting of each user set to each of the determination items.

17. The information processing device according to claim 13, wherein
the determination code is configured to cause at least one of said at least one processor to execute the determination based on a determination threshold for each user, the determination threshold being changed according to a number of calculations of the fraud determination score.

18. The information processing device according to claim 13, wherein
the level of fraud has at least three levels of a high fraud determination, a medium fraud determination, and a low fraud determination, and
the information processing device further comprises notification code configured to cause at least one of said at least one processor to notify an administrator of identification information of a user to whom the medium fraud determination has been given.

19. The information processing device according to claim 18, wherein
the notification code is configured to cause at least one of said at least one processor to notify a process result of each of the determination items together with identification information of the user.

20. The information processing device according to claim 13, wherein
the score calculation code is configured to cause at least one of said at least one processor to calculate the fraud determination score based on related fraud determination score.

21. The information processing device according to claim 13, wherein
the determination code is configured to cause at least one of said at least one processor to change a determination threshold such that the level of fraud is likely to be determined higher than usual in a predetermined period after a user information change operation and execute the determination.

22. An information processing method executed by an information processing device, comprising:
calculating, for each operation of a user, a fraud determination score based on a determination item according to an operation type;
determining, in response to an operation of a user, a level of fraud of an operation based on a log of the fraud determination score of an operation type identical to an operation type of the operation;
executing, on a user who has executed an operation determined as having a high possibility of fraud regarding the level of fraud, an identity confirmation process at a time of the operation; and
executing a payment method change process on a user determined as having a high possibility of fraud at a time of product purchase.

23. A non-transitory computer readable storage medium having stored thereon a computer program configured to cause an information processing device to:
calculate, for each operation of a user, a fraud determination score based on a determination item according to an operation type;
determine, in response to an operation of a user, a level of fraud of the operation based on a log of the fraud determination score of an operation type identical to an operation type of the operation;
execute, on a user who has executed an operation determined as having a high possibility of fraud regarding the level of fraud, an identity confirmation process at a time of the operation; and
execute a payment method change process on a user determined as having a high possibility of fraud at a time of product purchase.
